(19) United States
(12) Patent Application Publication
(10) Pub. No.: US 2005/0284508 A1
(43) Pub. Date: Dec. 29, 2005

(54) Device for water supply distribution to a plurality of consumption elements within a washing machine

(75) Inventors: Carlo Carli, Albizzate (VA) (IT); Giuseppe Borroni, Origgio (VA) (IT); Pietro Pala, Castelprio (VA) (IT)

Correspondence Address: LEVINE & MANDELBAUM, 444 MADISON AVENUE, 35TH FLOOR, NEW YORK, NY, 10022, US

(73) Assignee: T&P S.p.A., Tradate (IT)

(21) Appl. No.: 11/158,931

(22) Filed: Jun. 22, 2005

(30) Foreign Application Priority Data
Jun. 25, 2004 (IT) TO2004A000432

(51) Int. Cl. B08B 3/00

(52) U.S. Cl. 134/57 D; 134/115 R

(57) ABSTRACT

A device for water supply distribution to a plurality of consumption elements within a washing machine, e.g., a laundry washing machine, has a first shell, a motor, apparatus for connection to the electronic control board of the washing machine, detection apparatus for detecting the different wash phases, a second shell and a distributor. The distributor is positioned coaxially to said motor.

### BACKGROUND OF THE INVENTION

The present invention relates to a device for water supply distribution to a plurality of consumption elements within a washing machine, in particular a laundry washing machine, comprising a first shell, a motor connecting means for the connection to the electronic control board of the washing machine, detection means for detecting the different washing phases, a second shell and a water distributor.

As known, washing machines, e.g. laundry washing machines, dishwashers, or such like, use water from the water main for dispensing washing agents (detergents or additives); in fact, water is made to pass through a washing agent dispensing drawer before entering the tub, so as to carry the washing agents into the wash tub.

It is also known that the washing agent dispensing drawer comprises a plurality of compartments, each of which is used for a different wash phase; for instance, washing machines made in Europe are generally fitted with dispensing drawers having four compartments for prewash, wash, bleaching and softener, respectively, whereas washing machines made in the USA generally have three compartments for wash, bleaching and softener, respectively. Of course, each type of washing agent must be dispensed individually from the corresponding compartment.

There are also cases wherein the washing agent dispensing drawer comprises a fifth compartment for the liquid detergent and a sixth compartment for an extra quantity of detergent for washing very dirty or badly soiled clothes.

In these distribution systems, the water is supplied to the various compartments by means of a device having a motor controlled by the electronic control board of the washing machine; said motor is located apart from a water flow distributor, and therefore the connection between the motor and the distributor takes place through mechanical linkages which allow to obtain the rotation of said distributor for directing the flow of water coming from the main towards the compartment containing the appropriate washing agent for every wash phase.

However, said systems have some drawbacks, such as the high number of components needed for transmitting the turning motion of the motor to the water flow distributor. This complexity inevitably means higher costs and inaccurate operation.

Besides, mounting the distributor apart from the motor requires both the use of rather complex mechanical linkages and a number of adjustments to compensate the various coupling tolerances due to mass production. As a matter of fact, the higher the number of components to be produced, the higher the risk of an incorrect assembly on the production line, resulting in higher costs both for the final product and for the assembly and repairs of each device.

### SUMMARY OF THE INVENTION

The present invention aims at solving the above-mentioned drawbacks of the known devices for distributing water to a plurality of consumption elements within a washing machine, in particular a laundry washing machine.

Within such a scope, a first object of the present invention consists in providing a device for water supply distribution to a plurality of consumption elements within a washing machine, in particular a laundry washing machine, said device being simple, compact and economical, and allowing, compared to known solutions, a higher operational reliability as well as a simpler and less costly production.

Another object of the present invention is to provide a device of the above-described type offering higher reliability and being easier to repair.

Another object of the present invention is to provide a device being easy to assemble thanks to the presence of suitable means for allowing a simple assembly of the different parts forming the device.

According to the present invention, these and further objects are attained through a device for water supply distribution to a plurality of consumption elements within a washing machine, in particular a laundry washing machine, incorporating the features of the annexed claims, which form an integral part of the present description.

### DESCRIPTION OF THE DRAWINGS

Further objects, features and advantages of the present invention will become apparent from the following detailed description and annexed drawings, which are supplied by way of non-limiting example, wherein:

FIG. 1 shows an exploded view of a device for water supply distribution to a plurality of consumption elements within a washing machine, according to the teachings of the present invention;

FIG. 2 shows a bottom perspective view of a first detail of the device of FIG. 1;

FIG. 3 shows a bottom perspective view of a second detail of the device of FIG. 1;

FIG. 4a shows a top view of a third detail of the device of FIG. 1;

FIG. 4b shows a bottom view of a possible realization of the device according to the teachings of the present invention;

FIG. 5a shows a perspective view of a fourth detail of the device of FIG. 1;

FIG. 5b shows a perspective view of a fifth detail of the device of FIG. 1.

### DESCRIPTION OF THE PREFERRED EMBODIMENT

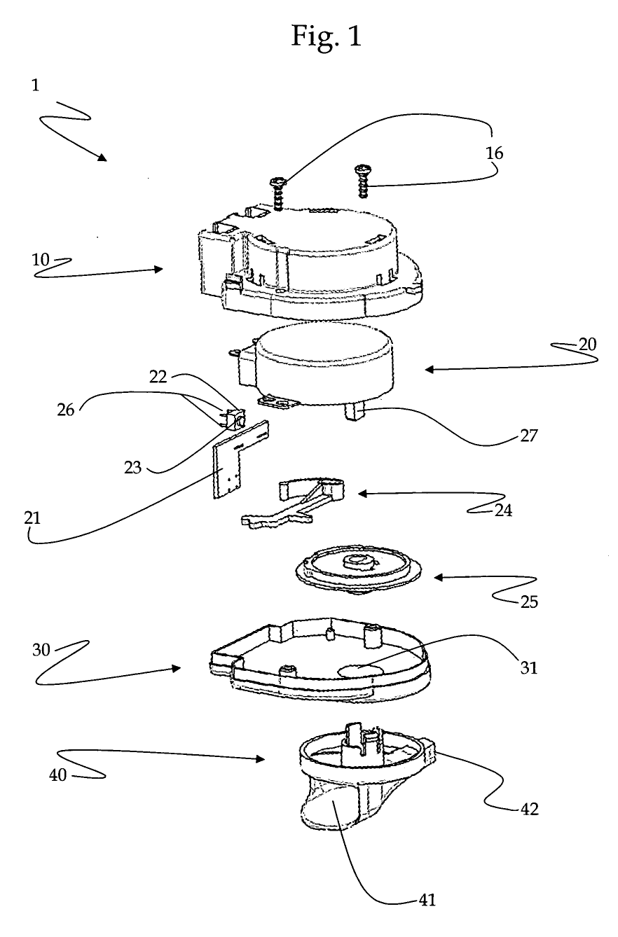

As to the description of the drawings, FIG. 1 shows an exploded view of a device 1 for water supply distribution to a plurality of consumption elements within a washing machine, being provided according to the teachings of the present invention; said device 1 comprises a first shell 10, a motor 20, means for detecting the different wash phases to be performed by the washing machine, a second shell 30 and a distributor 40.

The motor 20 preferably comprises a synchronous motor fitted with an incorporated motor reducer; a printed circuit 21 is fastened to the motor 20 through known fastening means, e.g. by welding.

In the embodiment of FIG. 1, the means for detecting the different wash phases to be performed by the washing machine comprise a microswitch 22, a lever 24 and a cam 25.

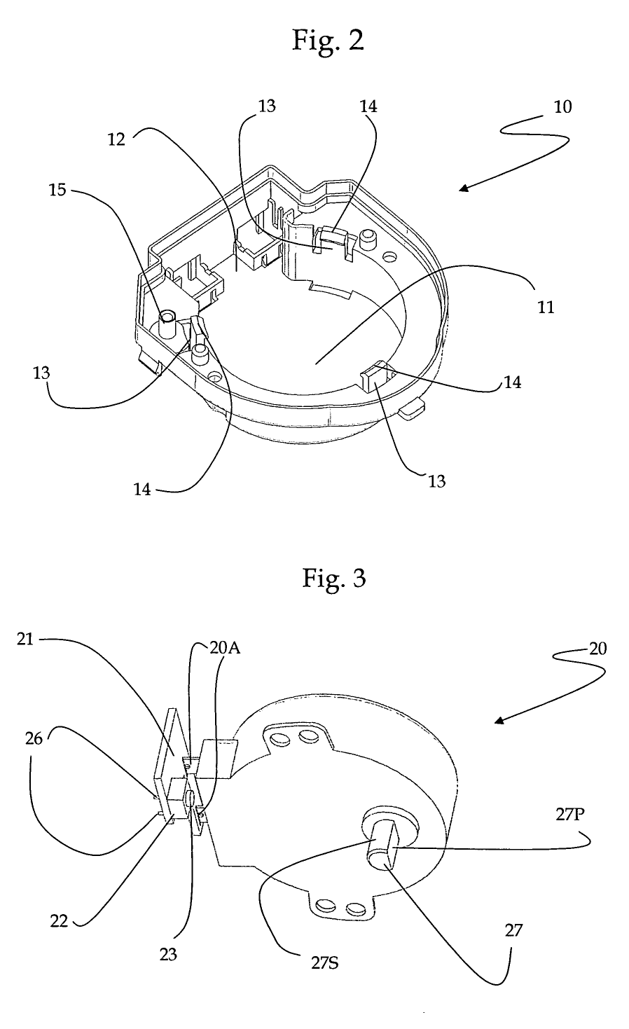

FIG. 2 shows a bottom perspective view of the first shell 10 of the device 1; said first shell 10 is fitted with a first space 11, being shaped and sized in such a way as to be able to receive the motor 20, and a second space 12, being suitable for containing the printed circuit 21.

The first shell 10 comprises hooking means allowing to couple the motor 20 to the first shell 10; in particular, said hooking means are located on the outer perimeter of the first space 11 and comprise a plurality of appendixes 13, each having a hooking tooth 14 on its end.

FIG. 3 shows a bottom perspective view of the motor 20, comprising the terminals 20A, e.g. of the type known as “Faston”; the tracks of the printed circuit 21 (not shown in the figures because of known type) and the terminals 20A are interconnected through means being known in the art, preferably before the motor 20 is coupled to the first shell 10. The terminals 20A and the printed circuit 21 are connected to the electronic control board of the washing machine, also not shown in the figures because of known type.

The microswitch 22 is positioned on the printed circuit 21 in such a way as to connect the contacts 26 of the microswitch 22 to the tracks of the printed circuit 21.

The motor 20 is provided with a shaft 27 which allows to turn the distributor 40; according to a preferred embodiment, the shaft 27 has a flat wall 27P and a semicylindrical wall 27S. The outer shape of the shaft 27 allows the cam 25 to be coupled to the motor 20 through known reciprocal hooking means, not shown in the illustrations.

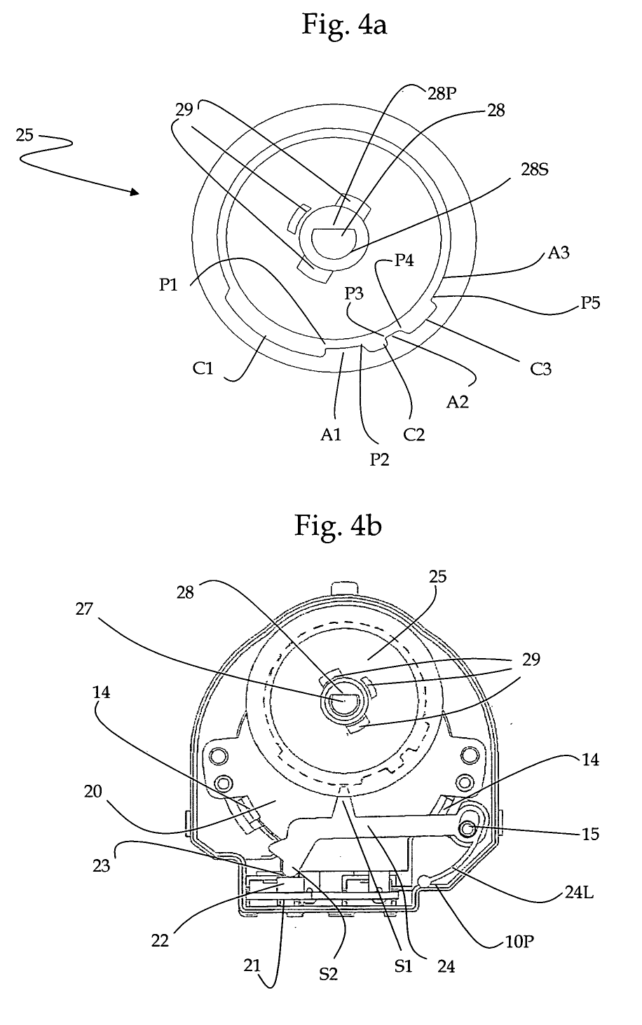

FIG. 4a shows a top view of the cam 25; said cam 25 is provided with an opening 28 having a shape being complementary to that of the shaft 27, as it also has a flat wall 28P and a semicylindrical wall 28S. In order to couple the cam 25 to the shaft 27 of the motor 20 correctly, it is sufficient to position the cam 25 in such a way as to create a contact between the flat wall 27P of the shaft 27 and the flat wall 28P of the opening 28.

The design of the cam 25 is based on the number of compartments contained within the washing agent dispensing drawer of the washing machine, said compartments being selected according to the different wash phases.

In particular, the cam 25 has a number of ridges C1, C2, C3 being equal to [1+integer (N/2)] ridges, wherein N is the number of compartments of the dispensing drawer and corresponds to the number of positions in which the distributor 40 must stop in order to supply water from the main into said compartments. Supposing that N is five, we will have [1+integer (5/2)] ridges, and the cam 25 will comprise three ridges C1, C2, C3.

The number of ridges C1, C2, C3 of the cam 25 is therefore proportional to the number of compartments of the washing agent dispensing drawer.

In the following pages we will always refer, by way of example, to a washing agent dispensing drawer having five compartments and to a cam 25 comprising three ridges C1, C2, C3; for a number of compartments of the washing agent dispensing drawer being higher or lower than five, it will be sufficient to use a cam 25 having an appropriate number of ridges.

In the embodiment of FIG. 4a, the three ridges C1, C2, C3 are obtained on the outer profile of said cam 25; yet they may be also located on the top or bottom surface of the cam 25.

In this specific case, the ridge C1 has a length of about sixty degrees and is followed by a first sinking A1 of magnitude twenty degrees; the point where the ridge C1 and the sinking Al meet corresponds to a first position P1.

The first sinking A1 is followed by the ridge C2 having a length of about ten degrees; the point where the sinking A1 and the ridge C2 meet corresponds to a second position P2.

The ridge C2 is followed by a second sinking A2 having a length of ten degrees; the point where the ridge C2 and the second sinking A2 meet corresponds to a third position P3.

The second sinking A2 is followed by the ridge C3 having a length of about twenty degrees; the point where the sinking A2 and the ridge C3 meet corresponds to a fourth position P4.

The ridge C3 is followed by a third sinking A3 and the point where they meet corresponds to a fifth position P5.

The above positions P1, P2, P3, P4, P5 correspond to the points where the motor 20 must be stopped by the electronic control board of the washing machine in order to allow the distributor 40 to supply water from the main into the compartments of the washing agent dispensing drawer.

FIG. 4b shows a bottom view of the cam 25 mounted on the shaft 27 of the motor 20; the broken line represents the profile of the cam 25.

The lever 24 is snap-hooked and pivoted on a pin 15 of the first shell 10, and is provided with a first projection S1 and a second projection S2, being located on opposite sides with respect to the axis of the lever 24.

The first projection Si is positioned against the cam 25, so as to allow the lever 24 to follow the profile of said cam 25; the second projection S2 is positioned close to a push-button 23 of the microswitch 22.

The lever 24 is also fitted with elastic means being suitable for keeping the lever 24 in contact with the cam 25; in FIG. 4a said elastic means comprise a tang 24L, obtained directly during the molding of said lever 24, which rests against the side wall 10P of the upper shell 10 in order to keep the lever 24e in a pretensioned state.

Rotating together with the shaft 27 of the motor 20, the cam 25 causes an oscillatory motion of the first projection S1 of the lever 24 through the ridges C1, C2, C3 and the sinkings A1, A2, A3; in its turn, the second projection S2 of the lever 24 transmits said motion to the push-button 23 of the microswitch 22, so as to allow for the “on/off” switching of said microswitch 22.

In particular, the microswitch 22 is “on” when the first projection S1 is in a position corresponding to one of the ridges C1, C2, C3 and the second projection S2 is pressing the push-button 23; vice versa, the microswitch 22 is “off” when the first projection S1 is in a position corresponding to one of the sinkings A1, A2, A3 and the second projection S2 is not pressing the push-button 23.

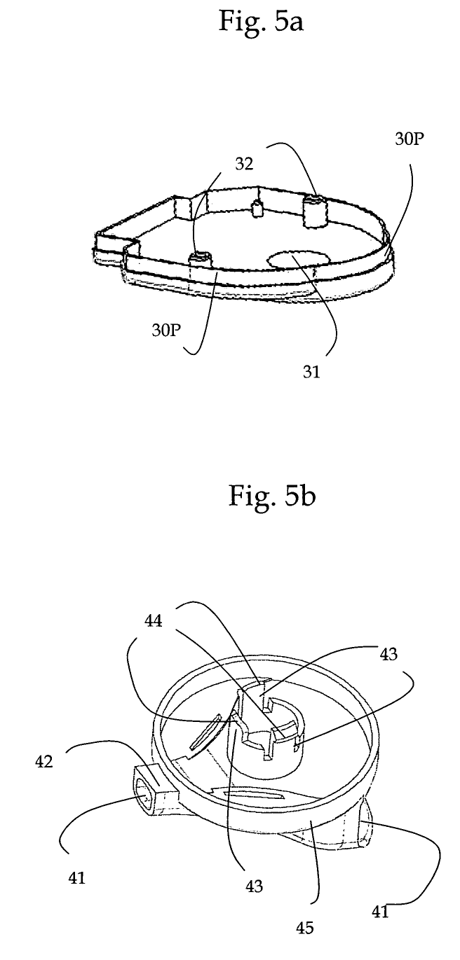

FIGS. 5a and 5b show a perspective view of the second shell 30 and of the distributor 40, respectively.

The second shell 30 has a passage 31 and side walls 30P shaped as to be hooked to the side walls 10P of the first shell 10. In order to fasten the second shell 30 to the first shell 10, one may also use further fastening means known in the art, such as screws 16 (shown in FIG. 1) to be screwed into seats 32 on the second shell 30.

The second shell 30 and the washing agent dispensing drawer are provided with reciprocal hooking means, not shown in the figures because known in the art, which allow to fasten the device 1 to said washing agent dispensing drawer.

The second shell 30 may be equipped with tubing for the connection of the device 1 to the main, not shown in the figures because of a known type; as an alternative, the pipe fittings for the connection to the main may be located on the washing agent dispensing drawer.

The distributor 40 comprises a duct 41 suitable for being connected in a known way to the pipe fittings located in the second shell 30 or in the washing agent dispensing drawer, and a nozzle 42 which allows to supply water from the main into the different compartments of the washing agent dispensing drawer, in accordance with the program set by the electronic control board of the washing machine.

The distributor 40 is also fitted with hooking means comprising appendixes 43, each having a tooth 44 on its end; such hooking means allow to mount said distributor 40 coaxially to the axis of the motor 20, as the teeth 44 are snap-hooked into slots 29 being present in the cam 25.

A wall 45 is obtained on the upper portion of the distributor 40; said wall 45 is suitable for going against the bottom surface of the second shell 30, so as to obstruct the opening 31 and prevent any splashes of water coming from the main from reaching the motor 20 and/or the printed circuit 21 and/or the microswitch 22.

The device 1 operates very simply as follows:

The electronic control board of the washing machine operates the motor 20, which allows the cam 25 and the distributor 40, mounted coaxially to said motor 20, to complete a whole turn in about twenty-four seconds.

During the rotation of the cam 25, the contact between the first projection S1 of the lever 24 and the sixty degrees of the ridge C1 lasts more than three seconds, in particular approximately four seconds.

When the first projection S1 arrives at position P1, the second projection S2 goes away from the push-button 23 and the microswitch 22 switches from “on” to “off”. The electronic control board of the washing machine stops the motor 20 in order to allow the distributor 40 to supply water from the main into a first compartment of the washing agent dispensing drawer.

Once the washing machine has completed the first water supply phase and the subsequent wash, the electronic control board energizes the motor 20 to turn the toothed cam 25 up to the point where the first projection S1 arrives at position P2 and the microswitch 22 switches from “off” to “on”; this rotation of twenty degrees of the sinking Al requires approximately one second and a half.

The electronic control board of the washing machine stops the motor 20 when the first projection S1 arrives at position P2, in order to allow the distributor 40 to supply water from the main into a second compartment of the washing agent dispensing drawer.

Once the second wash phase is completed, the motor 20 is energized until the microswitch 22 switches from “on” to “off”, i.e. when the first projection S1 arrives in position P3. The rotation of ten degrees of the cam 25, corresponding to the ridge C2, occurs in less than a second.

In position P3, the distributor 40 supplies water from the main into a third compartment of the washing agent dispensing drawer.

Once the washing machine has completed the third wash phase, the motor 20 is energized until the microswitch 22 switches from “off” to “on”, i.e. in position P4. Also in this case the rotation of ten degrees, corresponding to the sinking A2, occurs in less than a second. In position P4, the distributor 40 supplies water from the main into a fourth compartment of the washing agent dispensing drawer.

Once the fourth wash phase is completed, the motor 20 is energized until the microswitch 22 switches from “on” to “off”, i.e. in position P5. The rotation of twenty degrees of the cam 25, corresponding to the ridge C3, occurs in approximately one second and a half.

In position P5, the distributor 40 supplies water from the main into a fifth compartment of the washing agent dispensing drawer.

Once the washing machine has completed the whole wash cycle, the electronic control board energizes the motor 20 in order to turn the cam 25 until the microswitch 22 is switched twice, in particular when the first projection S1 arrives at:

the beginning of the ridge C1, i.e. the point where the microswitch 22 switches from “off” to “on”;

the end of the ridge C1, i.e. in position P1, where the microswitch 22 switches from “on” to “off”.

Finally, when the first projection S1 of the lever 24 arrives at position P1, the electronic control board of the washing machine stops the motor 20 and the washing machine is ready for a new wash cycle.

From the above description it may be easily understood that, thanks to the coaxial positioning of the distributor 40 with respect to the cam 25 and the motor 20 according to the present invention, the position of the distributor 40 can be easily detected and possibly changed by the electronic control board of the washing machine.

In fact, the known electronic control boards for washing machines are perfectly able to store and process the signals sent by the microswitch 22 in order to evaluate the position of the cam 25 and consequently of the distributor 40.

The electronic control board receives the “on” and “off” signals from the microswitch 22 and controls the motor 20 in order to position the distributor 40 based on the recognition of the signals coming from the microswitch 22, with every signal related to the switching from “on” to “off” or from “off” to “on” of the microswitch 22 representing a very precise point being suitable for identifying the position of the distributor 40 without any risk of error.

Furthermore, the electronic control board can also detect the ridge C1, which in fact is detected when the microswitch 22 remains in the “on” state for at least three seconds, in particular almost four seconds. At the end of an “on” state of the microswitch 22 lasting at least three seconds and just as the microswitch 22 is about to switch from “on” to “off”, i.e. in position P1, the motor 20 is stopped by the electronic control board and the washing machine is ready for a new wash cycle.

The ridge C1 also allows to reset the device 1, in particular whenever the washing machine is turned off before completing a wash cycle. In these cases, in order to prevent any problems due to a possible wrong positioning of the distributor 40, the cam 25 can be turned until the electronic control board detects the ridge C1. In fact, since the electronic control board of the washing machine has memorized the number of switchings performed by the microswitch 22 before the washing machine has been turned off and has found the ridge C1 (which may be defined as “reset ridge” of the device 1), the electronic control board of the washing machine is also able to re-position the distributor 40 at the point where it was at the moment of the interruption of the wash cycle.

From the above description it may also be easily understood that the device 1 for water supply distribution to a plurality of consumption elements within a washing machine according to the present invention is particularly simple and easy to assemble.

In fact, as already said, the tracks of the printed circuit 21 are connected through known means to the contacts 26 of the microswitch 21 and to the terminals 20A of the motor 20.

The assembly of the device 1 therefore takes place according to the following phases:

the motor 20, connected to the printed circuit 21, is inserted within the first compartment 11 so far as the hooking means of the first shell 10, comprising the appendixes 13 and the teeth 14, allow to couple the motor 20 to said first shell 10;

the cam 25 is coupled coaxially to the shaft 27 of the motor 20, in particular by positioning the cam 25 in such a way as to create a joint between the flat wall 27P of the shaft 27 and the flat wall 28P of the opening 28;

the lever 24 is snap-hooked and pivoted on the pin 15 of the first shell 10, the first projection S1 and the secod projection S2 of the lever 24 being positioned against the profile of the cam 25 and close to the push-button 23 of the microswitch 22, respectively. The elastic means of the lever 24, in particular the tang 24L, allow the lever 24 to remain in contact with the cam 25;

the fastening means of the distributor 40, comprising the appendixes 43 having teeth 44, are routed through the passage 31 of the second shell 30 and are snap-hooked into the slots 29 of the cam 25, so as to position the distributor 40 coaxially with respect to the motor 20 and the cam 25;

the second shell 30 is coupled to the first shell 10.

At this point it will only be necessary to:

fasten the device 1 to the washing agent dispensing drawer of the washing machine through the reciprocal hooking means of the second shell 30 and of the washing agent dispensing drawer;

connect the duct 41 of the distributor 40 to the pipe fittings for the connection to the main, being located on the second shell 30 or on the washing agent dispensing drawer;

connect the printed circuit 21 and the motor 20 to the electronic control board of the washing machine.

The coaxial positioning of the distributor 40 with respect to the motor 20 and the cam 25 according to the present invention permits to obtain a miniaturization of the whole device 1 and to simplify its insertion into common washing machines.

The features of the device for water supply distribution to a plurality of consumption elements within a washing machine according to the present invention are apparent from the above description and annexed drawings.

The above description has also clarified the advantages of the device for water supply distribution to a plurality of consumption elements within a washing machine according to the present invention.

In particular, the coaxial positioning of the distributor 40 with respect to the motor 20 allows to direct the flow of water from the main toward the compartment containing the appropriate washing agent for every wash phase without using complex mechanical linkages.

A further advantage of the device according to the present invention is the fact that the number of components used for transmitting the turning motion from the motor 20 to the distributor 40 is considerably lower than that needed by any device known in the art; the remarkable advantages offered by this solution are therefore apparent both from an economical point of view, there is a lower probability of having incorrect assembly on the production line, and reject pieces as finish product both from a point of view of ease of assembly, functional precision and greater reliability of device.

Another advantage is given by the fact that the assembly of the device is further simplified by the reciprocal hooking means of the various parts forming the device 1, in particular the hooking means of the distributor 40, which allow the distributor 40 to be positioned coaxially to the motor 20.

Moreover, thanks to the coaxial positioning of the distributor 40 with respect to the other components, the device 1 according to the present invention has a very compact structure and very small dimensions; this simplifies its insertion into common washing machines, in particular into suitable openings of the washing agent dispensing drawers.

It is clear that the man skilled in the art may introduce many changes to and applications of the device for water supply distribution to a plurality of consumption elements as described by way of example, without departing from the novelty spirit of the invention; likewise, it is also clear that in the final implementation of the invention the various components may have different shapes and dimensions or be replaced with other technically equivalent elements.

According to one of the many possible modifications, the cam 25 may be provided in such a way as to act directly onto the microswitch 22; in such an embodiment, the ridges C1, C2, C3 would go against the push-button 23, thereby switching the microswitch 22 without needing the lever 24 or any other known feeler means. This variant would allow for a further simplification of the assembly of the device 1.

Another possible variant may provide for the replacement of the ridges C1, C2, C3 of the cam 25 with other means known in the art. In particular, the cam 25 may have a track made of an electrically conductive material, suitable for being detected by feeler means comprising metal strips, thereby causing the switching from “on” to “off” (and vice versa from “off” to “on”) of the microswitch 22.

It can therefore be easily understood that the present invention is not limited to the device described above in all its various components, but may be subject to many modifications, improvements or replacements of equivalent parts and elements without departing from the novelty spirit of the inventive idea, as clearly specified in the following claims.

1. A device for water supply distribution to a plurality of consumption elements within a washing machine comprising:
a first shell,
a motor,
connecting means for connecting the device to an electronic control board of the washing machine,
detection means for detecting the different wash phases,
a second shell, and
a distributor,
wherein
said distributor is positioned coaxially with respect to said motor.

2. A device according to claim 1, wherein said distributor comprises hooking means having a plurality of appendages each of which has a tooth.

3. A device according to claim 1 wherein said distributor comprises a duct adapted to be connected to a water main through tubings, and a nozzle.

4. A device according to claim 3, wherein said tubings for connection to the water main are located in said second shell.

5. A device according to claim 1, wherein each of said plurality of consumption elements comprises a compartment of a drawer for dispensing washing agents.

6. A device according to claim 3, wherein said nozzle is adapted for supplying water from the main into said plurality of compartments.

7. A device according to claim 3, wherein said tubings for the connection to the water main are located in said washing agent dispensing drawer.

8. A device according to claim 1, wherein a wall is disposed on the upper portion of said distributor for obstructing a passage of said second shell and preventing the water coming from the water main from reaching said motor and/or said detection means and/or said connecting means.

9. A device according to claim 1, wherein said first shell has a first space shaped and sized to be able to contain said motor, and comprises hooking means for coupling the motor to the first shell.

10. A device according to claim 1, wherein said first shell has a second space for containing said connecting means.

11. A device according to claim 1, wherein said motor is a synchronous motor comprising a motor reducer and terminals of the “Faston” type.

12. A device according to claim 1, wherein said connecting means for the connection to the control board of the washing machine comprise a printed circuit.

13. A device according to claim 11, wherein said terminals are connected to electrical tracks in said printed circuit.

14. A device according to claim 1, wherein said motor comprises a shaft for turning said distributor.

15. A device according to claim 1, wherein said detection means comprises a microswitch having contacts for connection to the electrical tracks of said printed circuit.

16. A device according to claim 15, wherein said microswitch comprises a push-button.

17. A device according to claim 1, wherein said detection means comprises a cam.

18. A device according to claim 14, wherein said cam is has an opening with a shape complementary to that of said shaft for enabling said cam to be coaxially coupled to said motor.

19. A device according to claim 17, wherein said cam comprises a plurality of ridges.

20. A device according to claim 5, wherein the number of said ridges is a function of the number of compartments of the washing agent dispensing drawer.

21. A device according to claim 16, wherein said plurality of ridges is positioned against said push-button, so as to cause the switching of the microswitch.

22. A device according to claim 19, wherein at least one ridge of said plurality of ridges allows the device to be reset at the end of every wash cycle.

23. A device according to claim 15, wherein said cam comprises a track made of an electrically conductive material for causing the switching of said microswitch.

24. A device according to the claim 23 comprising metal strips for detecting the position of said track made of an electrically conductive material.

25. A device according to claim 17, wherein said detection means comprises a lever for detecting the position of said cam, said lever having elastic means for keeping said lever in contact with said cam.

26. A device according to claim 25, wherein said elastic means comprises a tang formed during the molding of said lever.

27. A device according to claim 25, wherein said lever is snap-hooked and pivoted on a pin of the first shell.

28. A device according to claim 1, wherein said second shell has side walls shaped for being coupled to the side walls of the first shell.

29. A washing machine comprising a device for water supply distribution to a plurality of consumption elements, said consumption elements comprising a plurality of compartments of a washing agent dispensing drawer.

30. A method for assembling a device for water supply distribution to a plurality of consumption elements within a washing machine, said device comprising:
a first shell,
a motor,
connecting means for the connection to the control board of the washing machine,
detection means for detecting the different wash phases,
a second shell,
a distributor,
wherein said distributor is positioned coaxially with respect to said motor.

31. A method according to claim 30, wherein said distributor is coupled to a cam, said cam being hooked coaxially to said motor.

32. A method according to claim 30, wherein said first shell, said motor, said detection means, said second shell and said distributor are assembled through reciprocal hooking means.

33. A method according to claim 32, comprising a phase for producing elastic means during the molding of said detection means.
